(19) United States
(12) Patent Application Publication
(10) Pub. No.: US 2006/0145974 A1
(43) Pub. Date: Jul. 6, 2006

(54) Power management for display device

(76) Inventors: Thomas E. Willis, Mountain View, CA (US); Samson X. Huang, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,127

(22) Filed: Dec. 30, 2004

(51) Int. Cl. G09G 3/34

(52) U.S. Cl. 345/84

(57) ABSTRACT

In some embodiments, a line of pixel elements may be divided into two or more segments. A buffer circuit may be configured to isolate one of the segments from one or more of the other segments. The buffer circuit may be configured to selectively provide a drive signal to the isolated segment. Other embodiments are disclosed and claimed.

The invention relates to display systems and more particularly to display devices and methods of operating display devices.

### BACKGROUND AND RELATED ART

A spatial light modulator (SLM) is a device which imparts information onto a light beam. For example, SLMs include liquid crystal devices (LCD—reflective and transmissive) and micro-electronic mirror systems (MEMS). SLMs are useful as part of display devices. One known type of display device utilizing an SLM is an LCD having a liquid crystal (LC) material which is driven by electronics located under each pixel. There are many known pixel architectures for these devices, each of which utilizes different structures and techniques to drive the pixel elements.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a block diagram of a display device in accordance with some embodiments of the present invention.

FIG. 2 is a block diagram of another display device in accordance with some embodiments of the present invention.

FIG. 3 is a block diagram of another display device in accordance with some embodiments of the present invention.

FIG. 4 is a schematic diagram of another display device in accordance with some embodiments of the present invention.

FIG. 5 is a schematic diagram of another display device in accordance with some embodiments of the present invention.

FIG. 6 is a block diagram of a display system in accordance with some embodiments of the present invention.

FIG. 7 is a block diagram of a method of operation in accordance with some embodiments of the present invention.

FIG. 8 is a block diagram of another display system in accordance with some embodiments of the present invention.

FIG. 9 is a block diagram of another display system in accordance with some embodiments of the present invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

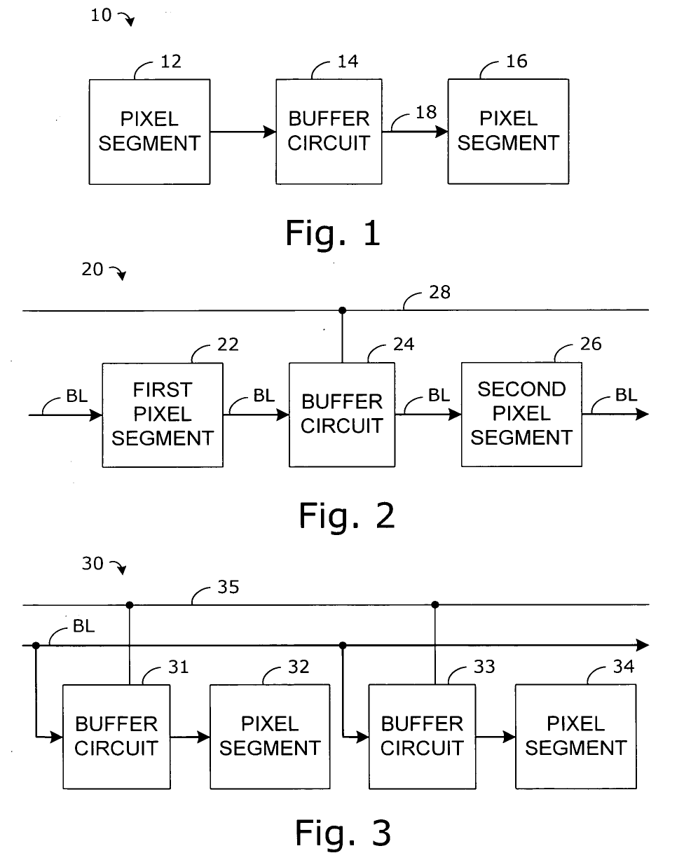

With reference to FIG. 1, a display device 10 includes a line of pixel elements divided into two or more segments 12 and 16, and a buffer circuit 14 configured to isolate one of the segments 16 from one or more of the other segments 12, wherein the buffer circuit 14 is configured to selectively provide a drive signal 18 to the isolated segment 16. For example, the buffer circuit 14 may include a logic gate configured to receive the drive signal 18 at one input and a control signal at another input, and selectively output the drive signal 18 to the isolated segment 16 in accordance with the control signal. For example, the drive signal may correspond to a bit line signal and the control signal may correspond to a segment enable signal.

For example, the display device 10 may include an array of pixel cells arranged in lines and one or more buffer circuits 14 may be configured to divide each line into two or more line segments. In some embodiments, the pixel segments and the buffer circuit(s) may be provided on the same integrated circuit. Alternatively, some or all of the buffer circuit(s) may be provided on one or more circuits not integrated on the same die with the pixel segments, but electrically coupled thereto.

The array of pixel cells may be addressed in a similar fashion to a memory device. Namely, a word line may select a row of the pixel array for update, and a per-column set of bit lines may provide control information to update the pixels in the selected row. However, in contrast to a memory device, the vertical height of the pixel array may be constrained by the desired physical geometry of the pixel array, as opposed to the less constraining electronic circuits of the memory device (which have no requirement for particular physical arrangement of memory cells). In conventional display devices, very long bit lines and word lines may require relatively high power for drive signals on those lines. Advantageously, some embodiments of the invention may reduce the loading on the bit lines and/or word lines and thus reduce the average power required to drive bit lines and/or word lines in a pixel array (e.g. of a spatial light modulator).

With reference to FIG. 2, a display device 20 includes a line of pixel elements divided into two or more segments 22 and 26, and a buffer circuit 24 configured to isolate one of the segments 26 from one or more of the other segments 22, wherein the buffer circuit 24 is configured to selectively provide a drive signal BL to the isolated segment 26. In some embodiments, the buffer circuit 24 may receive a control signal 28 and may be configured to selectively provide the drive signal BL to the isolated segment 26 in accordance with the control signal 28. For example, the buffer circuit 24 may be configured to receive the drive signal BL at one input and the control signal 28 at another input, and selectively output the drive signal BL to the isolated segment 26 in accordance with the control signal 28.

With reference to FIG. 3, a display device 30 includes a line of pixel elements divided into two or more segments 32 and 34, and two or more corresponding buffer circuits 31 and 33 configured to isolate each of the two or more segments 32 and 34 from each of the other segments 32 and 34 and selectively provide the drive signal BL to each isolated segment 32 and 34. In some embodiments, the buffer circuits 31 and 33 may each receive a control signal 35 and may be configured to selectively provide the drive signal BL to the isolated segments 32 and 34 in accordance with the control signal 35.

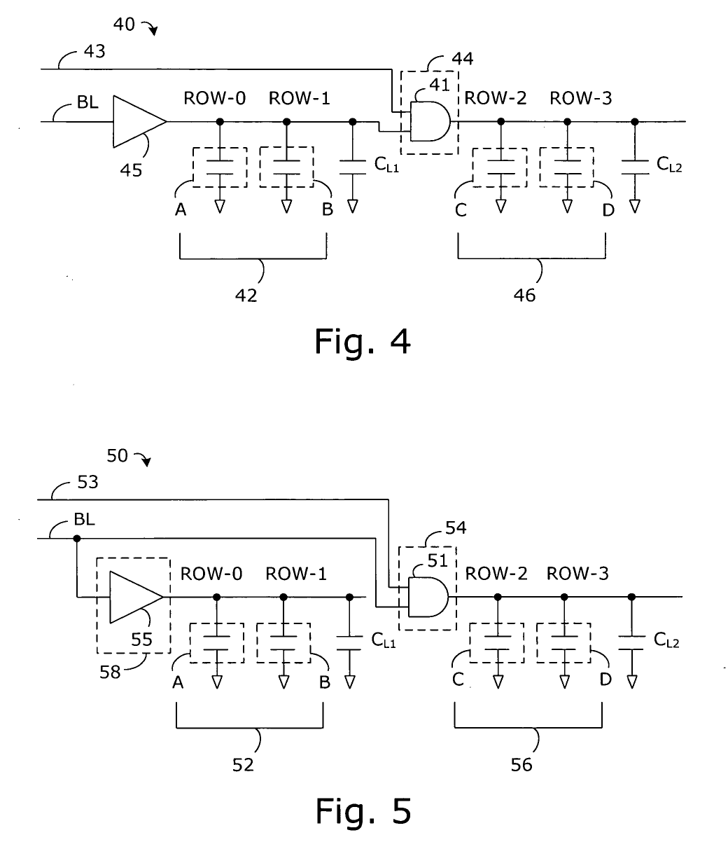

With reference to FIG. 4, a display device 40 includes a line of pixel elements (A, B, C, and D) divided into two or more segments 42 and 46, and a buffer circuit 44 configured to isolate one of the segments 46 (including pixel elements C and D) from one or more of the other segments 42 (including pixel elements A and B), wherein the buffer circuit 44 is configured to selectively provide a drive signal BL to the isolated segment 46. In some embodiments, the buffer circuit 44 may receive a control signal 43 and may be configured to selectively provide the drive signal BL to the isolated segment 46 in accordance with the control signal 43.

The pixel elements A, B, C, and D may each be represented by a capacitor having a per-pixel capacitive load of C_{P}. In general terms, the power utilized to drive a signal line may be written as:
P=CV²f
where C is the capacitance of the signal line, V is the rail voltage, and f is the frequency at which the line toggles. Advantageously, some embodiments of the invention may reduce C in the average case.

For example, a display device may sequentially update the rows of the pixel array. The update may start from row 0 and work toward row n−1. In a conventional display device, the bit line signal may be loaded by all of the pixel elements along a line (e.g. the column), together with some lumped line capacitance (C_{L}). According to some embodiments, the line of pixel elements may be divided into two or more isolated segments which can be selectively enabled.

Likewise, the drive signal may be broken into multiple segments of adjacent rows. For example, each segment may be isolated from the others by a tri-state buffer.

For example, the buffer circuit 44 may include a logic gate such as an AND gate 41. The bit line drive signal BL may be provided to a drive circuit 45 which provides the drive signal to one input of the AND gate 41. The control signal 43 may be considered a segment enable signal 43 for the isolated segment 46. The first segment 42 with pixel elements A and B may correspond to ROW-0 and ROW-1 of the display device 40. The second segment 46 with pixel elements C and D may correspond to ROW-2 and ROW-3 of the display device 60. The line capacitance (CL) may be divided into two per-segment line capacitances, C_{L1} and C_{L2}, which are both less than the original line capacitance.

When the first two rows (ROW-0 and ROW-1) are being updated, the segment enable signal 43 may be OFF, such that the signal BL is not passed through the AND gate 41 to the isolated segment 46. Advantageously, when the control signal 43 is OFF the signal BL is not loaded by the pixel elements C and D. In other words, the AND gate 41 is disabled and the bit line drive signal BL does not pass through to ROW-2 and ROW-3, and the pixel elements C and D do not draw significant power.

Accordingly, some embodiments of the invention may reduce the power by reducing the amount of line capacitance that must be driven for rows that are closer to the source of the bit line signal (this approach may reduce the average line capacitance). For example, the segment enable signal 43 may toggle at a much lower frequency than the bit line signal(s) BL. Also, any extra line capacitance on the segment enable signal 43 may be relatively small.

With reference to FIG. 5, a display device 50 is similar to the display device 40, except that the each segment is separately driven with the bit line signal without passing the bit line signal through the other segments. In other words, each pixel segment is isolated from the other pixel segments.

The display device 50 includes a line of pixel elements (A, B, C, and D) divided into two or more segments 52 and 56, and two or more corresponding buffer circuits 54 (e.g. AND gate 51) and 58 (e.g. drive circuit 55) configured to isolate each of the segments (e.g. segment 56 including pixel elements C and D) from each of the other segments (e.g. segment 52 including pixel elements A and B). The buffer circuit 54 is configured to selectively provide a drive signal BL to the isolated segment 56. The buffer circuit 58 is configured to provide the drive signal BL to the pixel segment 52. In some embodiments, the buffer circuit 54 may receive a control signal 53 and may be configured to selectively provide the drive signal BL to the isolated segment 56 in accordance with the control signal 53.

In this case, the additional loading seen for ROW-2 and ROW-3 includes only the line capacitance up to the buffer circuit 58, but not the pixel load for pixel elements A and B or the line capacitance C_{L1}. Depending on the number of rows and number of isolated segments, power consumption of the display device 50 may be reduced. Depending on the physical geometry and fabrication process, the number of separately driven pixel segments may be limited by the number of wires which may be effectively routed in the bit line direction.

In some embodiments, some power savings may be achieved even if all pixel elements in a line of pixels are not necessarily included in a pixel segment. It may not be necessary that all pixel segments have an identical number of pixel elements. Also, for some embodiments the circuits and techniques described above may be mixed such that some drive signals get passed through various pixel segments and some drive signals are directly applied to other completely isolated segments, with appropriate control signals (which may have more than one bit).

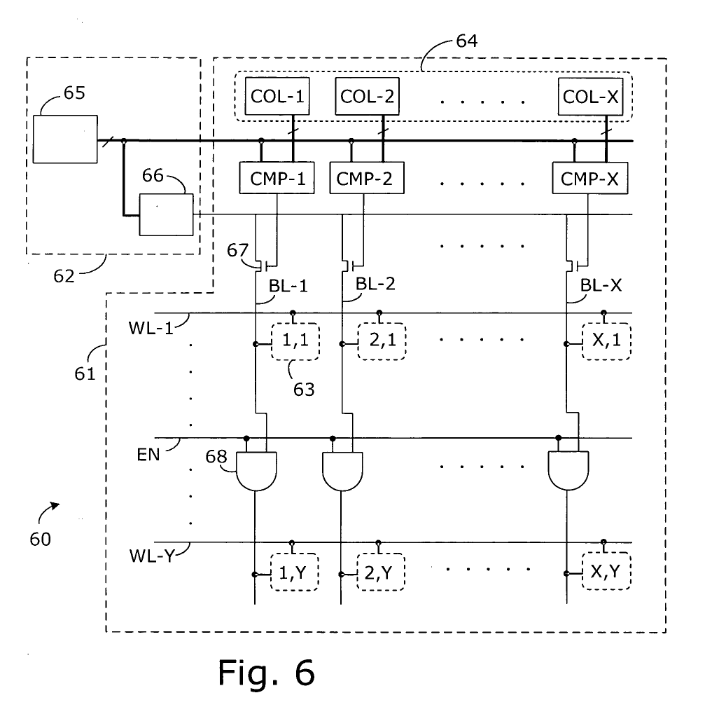

With reference to FIG. 6, a display system 60 includes a spatial light modulator (SLM) 61 coupled to a drive circuit 62, nominally partitioned in respective dashed boxes. The SLM 61 and the drive circuit 62 may be physically co-located on a same integrated circuit. Alternatively, various portions of the SLM 61 and/or the circuit 62 may be located on one or more circuits not integrated on the same die, but with appropriate connections therebetween. The SLM 61 includes an X by Y array of pixel cells 63, designated as cell 1,1 through cell X,Y. The SLM further includes a pixel input buffer 64 which is configured to provide pixel data on a column basis for columns 1 through X (e.g. with column pixel data buffers COL-1, COL-2, . . . COL-X). Pixel data for each column may be written to the corresponding rows 1 through Y by selectively enabling write lines WL-1 through WL-Y.

The drive circuit 62 may include a digital ramp circuit 65 and a digital to analog converter (DAC) circuit 66 (which may be linear or non-linear). For example, the digital ramp circuit 65 may provide an N bit wide output digital ramp signal which increments from zero (0) to 2^{N}−1 over a refresh cycle. In the illustrated embodiment, the DAC circuit 66 is connected to the output of the digital ramp circuit 65. The DAC circuit 66 may receive the digital ramp signal and output a corresponding non-linear analog ramp signal. For example, the analog ramp signal from the DAC circuit 66 is configured to refresh the array of pixel cells 1,1 through X,Y.

The SLM 61 may include a set of comparators CMP-1 through CMP-X which each receive a respective input from the pixel input buffer 64 and also the digital ramp signal. The analog ramp signal may be provided from the DAC 66 to each column's pixel cells through respective gating transistors 67 connected to respective bit lines BL-1 through BL-X. The output of the comparators are respectively provided to the gate of the gating transistors 67, such that when a pixel data value from the pixel input buffer 64 is less than the digital ramp value, the gating transistor is turned ON and the corresponding pixel cell receives the analog ramp signal. When the digital ramp value is equal to or greater than the pixel value, the gating transistor is turned OFF and the corresponding pixel cell no longer receives the analog ramp signal.

When a write line is active, the analog ramp signal is applied to the pixel cell over the bit line, for as long as the gating transistor 67 is turned ON. For example, the gating transistor 67 may be turned ON at the beginning of the refresh cycle and may stay on until the digital ramp value equals the pixel data value for the corresponding pixel cell, thus transferring an appropriate amount of charge to the pixel element in accordance with the analog ramp signal. Those skilled in the art will appreciate that the pixel cell may take various forms depending on the particular display technology of the SLM 61.

In accordance with some embodiments of the invention, the line of pixel cells arranged along a bit line signal are divided into two or more pixel line segments by a buffer circuit including a logic gate such as an AND gate 68. The bit line drive signal (e.g. BL-1) is provided to one input of the AND gate 68 and a segment enable signal EN is provided to the other input of the AND gate 68. When the EN signal is OFF, the pixel segment(s) on the output side of the AND gate 68 are isolated from the pixel segment(s) on the input side of the AND gate 68. When the EN signal is ON, the AND gate 68 selectively provides the bit line drive signal BL-1 to the pixel segment(s) on the output side of the AND gate 68. In some embodiments, three or more pixel segments may be provided together with respective corresponding buffer circuits.

Advantageously, when the rows on the input side of the AND gate 68 are being updated, the bit line drive signal is not loaded by the pixel cells on the output side of the AND gate 68, and the average line capacitance and power consumption may be reduced.

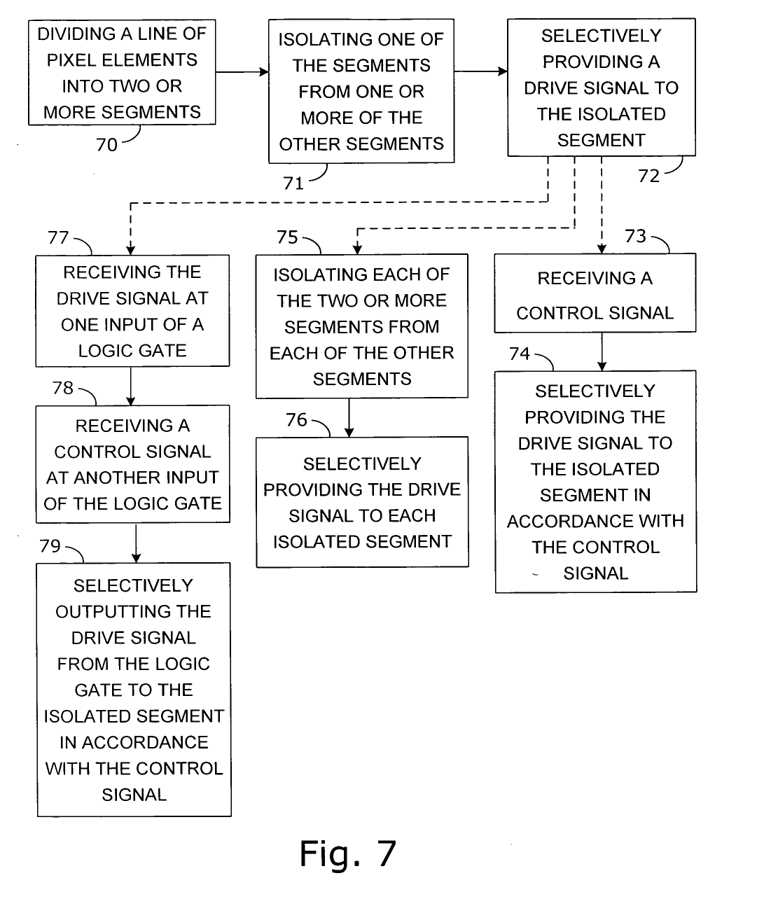

With reference to FIG. 7, some embodiments of the invention include dividing a line of pixel elements into two or more segments (e.g. at block 70), isolating one of the segments from one or more of the other segments (e.g. at block 71), and selectively providing a drive signal to the isolated segment (e.g. at block 72).

For example, some embodiments may further include receiving a control signal (e.g. at block 73), and selectively providing the drive signal to the isolated segment in accordance with the control signal (e.g. at block 74).

For example, some embodiments may further include isolating each of the two or more segments from each of the other segments (e.g. at block 75), and selectively providing the drive signal to each isolated segment (e.g. at block 76).

For example, some embodiments may further include receiving the drive signal at one input of a logic gate (e.g. at block 77), receiving a control signal at another input of the logic gate (e.g. at block 78), and selectively outputting the drive signal from the logic gate to the isolated segment in accordance with the control signal (e.g. at block 79). For example, the drive signal may correspond to a bit line signal and the control signal may correspond to a segment enable signal.

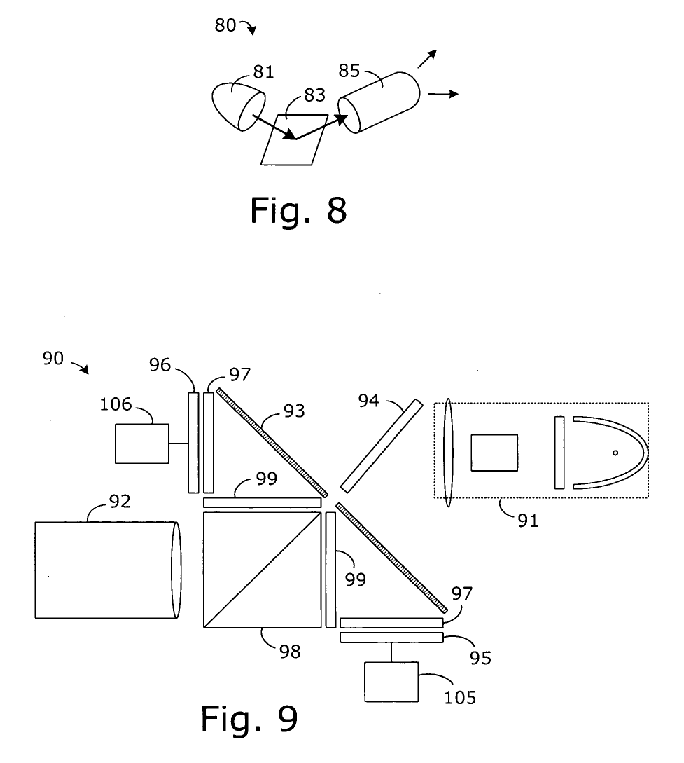

With reference to FIG. 8, a display system 80 according to some embodiments of the invention includes a light engine 81, a projection lens 85, and a spatial light modulator (SLM) 83 positioned between the light engine 81 and the projection lens 85. The SLM 83 may receive light from the light engine 81 and encode the light with image information. The projection lens 85 may receive the encoded light from the SLM 83 and project the encoded light (e.g. on a display screen). For example, the SLM 83 may include a line of pixel elements divided into two or more segments and a buffer circuit configured to isolate one of the segments from one or more of the other segments, wherein the buffer circuit is configured to selectively provide a drive signal to the isolated segment. For example, the buffer circuit may receive a control signal and may be configured to selectively provide the drive signal to the isolated segment in accordance with the control signal. For example, in the system 80 the spatial light modulator 83 may be a micro-electronic mirror device, a liquid crystal device, or another type of spatial light modulator.

With reference to FIG. 9, a display system 90 may include a light engine 91 and a projection subsystem 92, and utilize a wire grid polarizer 93 as a polarization beam splitter. Light from the light engine 91 is directed to a red dichroic mirror 94 which reflects red light through the WGP 93 to a first LCOS panel 95 and passes blue and green light through the WGP 93 to second LCOS panel 96. The LCOS panels 95 and 96 may have associated additional optical components 97, such as filters, lenses, etc. A color switch subsystem (not shown) may switch blue and green light on the second LCOS panel 96.

In some embodiments, the system 90 further includes a first buffer circuit 105 coupled to or integrated with the first LCOS panel 95, and a second buffer circuit 106 coupled to or integrated with the second LCOS panel 96, wherein the drive circuits are respectively configured to divide respective lines of pixels on the respective LCOS panels 95 and 96 into two or more segments and selectively isolate one or more of the segments. For example, the buffer circuits 105 and 106 may be configured to selectively provide bit line drive signals to the pixel segments to reduce power consumption of the LCOS panels 95 and 96.

Substantially polarized, modulated light from the first and second LCOS panels 95 and 96 is reflected by the opposite side of the WGP 93 onto respective faces of a combining prism 98. In accordance with some embodiments of the invention, and as illustrated in FIG. 9, clean-up polarizers 99 are disposed on each of the respective faces of the combining prism 98 which receive the substantially polarized, modulated light from the respective panels. Alternatively, a single clean-up polarizer may be disposed on an exit face of the combining prism 98, proximate to the entrance aperture of the projections lens 92.

Even though single or two-panel (or two PBS) display systems have been described above, according to some embodiments, more or less panels may be utilized in various embodiments of the invention. In many embodiments, single or multi-panel-based color imaging systems may be devised without departing away from the spirit of the present invention. An example of a panel is a liquid crystal on silicon (LCOS) panel, forming screen projection displays in projection display systems. Consistent with numerous embodiments of the present invention, color schemes other than a red-green-blue (RGB) format may be employed since the RGB format is simply used here for illustration purposes only.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An apparatus, comprising:
a line of pixel elements divided into two or more segments; and
a buffer circuit configured to isolate one of the segments from one or more of the other segments, wherein the buffer circuit is configured to selectively provide a drive signal to the isolated segment.

2. The apparatus of claim 1, wherein the buffer circuit receives a control signal and is configured to selectively provide the drive signal to the isolated segment in accordance with the control signal.

3. The apparatus of claim 2, wherein the buffer circuit is configured to receive the drive signal at one input and the control signal at another input, wherein the buffer circuit selectively outputs the drive signal to the isolated segment in accordance with the control signal.

4. The apparatus of claim 1, further comprising:
two or more buffer circuits configured to isolate each of the two or more segments from each of the other segments and selectively provide the drive signal to each isolated segment.

5. The apparatus of claim 1, wherein the buffer circuit comprises a logic gate configured to receive the drive signal at one input and a control signal at another input, wherein the logic gate selectively outputs the drive signal to the isolated segment in accordance with the control signal.

6. The apparatus of claim 5, wherein the drive signal corresponds to a bit line signal and wherein the control signal corresponds to a segment enable signal.

7. A method, comprising:
dividing a line of pixel elements into two or more segments;
isolating one of the segments from one or more of the other segments; and
selectively providing a drive signal to the isolated segment.

8. The method of claim 7, further comprising:
receiving a control signal; and
selectively providing the drive signal to the isolated segment in accordance with the control signal.

9. The method of claim 7, further comprising:
receiving the drive signal at one input of a buffer circuit;
receiving the control signal at another input of the buffer circuit; and
selectively outputting the drive signal from the buffer circuit to the isolated segment in accordance with the control signal.

10. The method of claim 7, further comprising:
isolating each of the two or more segments from each of the other segments; and
selectively providing the drive signal to each isolated segment.

11. The method of claim 7, further comprising:
receiving the drive signal at one input of a logic gate;
receiving a control signal at another input of the logic gate; and
selectively outputting the drive signal from the logic gate to the isolated segment in accordance with the control signal.

12. The method of claim 11, wherein the drive signal corresponds to a bit line signal and wherein the control signal corresponds to a segment enable signal.

13. A system, comprising:
a light engine;
a projection lens; and
a spatial light modulator positioned between the light engine and the projection lens, wherein the spatial light modulator includes:
a line of pixel elements divided into two or more segments; and
a buffer circuit configured to isolate one of the segments from one or more of the other segments, wherein the buffer circuit is configured to selectively provide a drive signal to the isolated segment.

14. The system of claim 12, wherein the buffer circuit receives a control signal and is configured to selectively provide the drive signal to the isolated segment in accordance with the control signal.

15. The system of claim 14, wherein the buffer circuit is configured to receive the drive signal at one input and the control signal at another input, wherein the buffer circuit selectively outputs the drive signal to the isolated segment in accordance with the control signal.

16. The system of claim 12, further comprising:
two or more buffer circuits configured to isolate each of the two or more segments from each of the other segments and selectively provide the drive signal to each isolated segment.

17. The system of claim 12, wherein the buffer circuit comprises a logic gate configured to receive the drive signal at one input and a control signal at another input, wherein the logic gate selectively outputs the drive signal to the isolated segment in accordance with the control signal.

18. The system of claim 17, wherein the drive signal corresponds to a bit line signal and wherein the control signal corresponds to a segment enable signal.

19. The system of claim 12, wherein the spatial light modulator comprises an array of pixel elements arranged in rows and columns, and wherein each row of the pixel array comprises a respective line of pixel elements divided into two or more segments and corresponding buffer circuits configured to isolate one of the segments in the respective line of pixels from one or more of the other segments in the respective line of pixels, wherein the buffer circuits are configured to selectively provide the drive signal to the isolated segments.

20. The system of claim 12, wherein the spatial light modulator comprises a micro-electronic mirror device.

21. The system of claim 12, wherein the spatial light modulator comprises a liquid crystal device.
